(19) United States
(12) Patent Application Publication
(10) Pub. No.: US 2015/0114672 A1
(43) Pub. Date: Apr. 30, 2015

(54) FIRE SUPPRESSION SYSTEMS AND METHODS

(71) Applicant: Integrated Systems Excellence Corporation, Quincy, MA (US)

(72) Inventor: Francis YEE, Quincy, MA (US)

(21) Appl. No.: 14/531,069

(22) Filed: Nov. 3, 2014

Related U.S. Application Data
(63) Continuation of application No. 12/556,665, filed on Sep. 10, 2009, now abandoned.
(60) Provisional application No. 61/173,825, filed on Apr. 29, 2009.
(60) Provisional application No. 61/202,264, filed on Feb. 12, 2009.
(60) Provisional application No. 61/193,912, filed on Jan. 7, 2009.
(60) Provisional application No. 61/193,911, filed on Jan. 7, 2009.
(60) Provisional application No. 61/136,521, filed on Sep. 11, 2008.

(51) Int. Cl. A62C 2/00

(52) U.S. Cl. CPC A62C 2/00
USPC 169/46; 169/70

(57) ABSTRACT

Tools and techniques for suppressing fires. Such tools might transmit a signal that generates one or more waves (which might be mechanical waves, electromagnetic waves, and/or the like) that is sufficient to disrupt the relationship between the electrons in a fire and the ionized nuclei to which those electrons are attracted. The resulting repulsion (between the nuclei and/or the electrons) that form the plasma of the fire can serve to disperse the plasma, thereby suppressing the fire.

### CROSS-REFERENCES TO RELATED APPLICATIONS

This application is a continuation of application Ser. No. 12/556,665 titled “Fire Suppression Systems and Methods” filed on Sep. 10, 2009 which claims the benefit of priority to U.S. Provisional Application No. 61/173,825 filed Apr. 29, 2009, U.S. Provisional Application No. 61/202,264 filed Feb. 12, 2009, U.S. Provisional Application No. 61/193,912 filed Jan. 7, 2009, U.S. Provisional Application No. 61/193,911 filed Jan. 7, 2009 and U.S. Provisional Application No. 61/136,521 filed Sep. 11, 2008.

The respective disclosures of these Incorporated Applications are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates to tools and techniques for suppressing fires.

### BACKGROUND

Traditionally, fire suppression has involved attempting to disrupt the chemical reactions within the fire using Halons, and/or smothering the fire (e.g., with carbon dioxide, inert materials, water, and/or the like) in order to reduce the temperature of the fire and starve the fire of oxygen. However, in many applications, the application of such chemical and smothering suppressants is impractical or ineffective. For example, in wild fires, such as forest fires, prairie fires, and the like, the dimensions of the fire make it difficult to apply such suppressants in sufficient volume or with sufficient speed to control the fire before significant damage is done. In other environments, such as the interior of a vehicle (such as a land vehicle, an aircraft, a spacecraft, or a watercraft), the use of traditional suppressants is problematic for a variety of reasons, including hazard to the occupants, the potential for damage to critical systems through the use of suppressant materials, and/or the impracticality of installing such a system in the relatively tight confines of such a vehicle. Moreover, the use and/or production of many suppressants, particularly including Halons, is hazardous to the environment. Fire suppression systems such as automatic sprinkler systems cause water damage.

Hence, there is a need for tools and techniques for suppressing fires in which the use of such smothering agents is not required.

### BRIEF SUMMARY

Various embodiments of the invention provide tools and techniques for suppressing fires. Certain embodiments, for example, transmit a signal that generates one or more waves (which might be mechanical waves, electromagnetic waves, and/or the like) that is sufficient to disrupt the relationship between the electrons in a fire and the ionized nuclei to which those electrons are attracted. The resulting repulsion between the nuclei that form the plasma of the fire can serve to disperse the plasma, thereby suppressing the fire.

In some cases, certain embodiments generate a signal that produces compression waves; in an aspect, these compression waves may produce a fast compression effect over an area (or volume) of the fire, resulting in the dispersion of the plasma and suppression of the fire. Certain embodiments provide the ability to shape these waves to enhance this fast compression effect.

In accordance with other embodiments, the signal might be generated with a plasma dispersion frequency that is calculated (based for example, on measured characteristics of the fire) to resonate with the frequency of the plasma itself, allowing the signal to disrupt the bond between the electrons and the nuclei and, consequently, disperse the plasma of the fire.

Particular embodiments may employ various features to enhance this dispersive effect. Merely by way of example, in some embodiments, the electrons may be grounded out of the plasma once separated from the nuclei of the plasma, thereby aggravating the repulsive forces between the positively-charged nuclei, and the repulsive forces between the negatively-charged electrons. An electron-grounding device, of which a Penning Trap is one of several examples, may be employed for this purpose.

Another enhancement that may be employed by various embodiments is the use of secondary compression. To name but one example, an airbag (similar, in some aspects, to the airbags used for passenger safety in vehicles) or other secondary compression device may be deployed near the fire. When rapidly expanded, the secondary compression device exerts additional compression on the fire, enhancing the dispersive effect of the transmitted signal.

Various embodiments can be employed on any scale. Merely by way of example, on a relatively small scale, a fire suppression system might be installed in the cabin of a aircraft or other vehicle, for suppressing cabin fires. On a larger scale, a signal generator might be installed on the exterior of such an aircraft, which can be flown proximate to a fire, such as a wildfire, to generate signals for suppressing the fire in accordance with various embodiments. In fact, the aircraft itself can act as a signal generator in some cases. Merely by way of example, the sonic boom generated by supersonic flight can produce a compression wave that will exert a fast compression effect on a fire, such as a wildfire, when the aircraft is flown proximate to the fire (e.g., directly over the fire, or directly across the path of the fire).

The tools provided by various embodiments include, without limitation, methods, systems, and/or software products. Merely by way of example, a method might comprise one or more procedures, some of which are executed by a computer system. Correspondingly, an embodiment might comprise a computer system configured with instructions to perform one or more procedures in accordance with methods provided by various embodiments. Similarly, a computer program might comprise a set of instructions that are executable by a computer system (and/or a processor therein) to perform such operations. In many cases, such software programs are encoded on physical and/or tangible computer readable media (such as, merely by way of example, optical media, magnetic media, and/or the like).

Merely by way of example, a system for suppressing a fire comprising plasma, in accordance with one set of embodiments, comprises a signal generator for transmitting a signal proximate to the fire. In an aspect of certain embodiments, the signal is sufficient to disperse at least a portion of the plasma and/or might have a plasma dispersion frequency. In other embodiments, the signal generator might comprise a compression wave generator for generating a set of one or more compression waves; the one or more compression waves collectively may be sufficient to disperse at least a portion of the plasma.

The system, in accordance with some embodiments, further comprises an active gain control circuit, in communication with the signal generator, for adjusting one or more characteristics of the signal, and/or a computer system in communication with the active gain control circuit. In one aspect, the computer system might comprise a processor and a set of instructions (which might be stored on a computer readable storage medium) that are executable by the processor to calculate values for the one or more characteristics of the signal.

Another set of embodiments provides methods. An exemplary method comprises identifying a fire comprising plasma and transmitting a signal proximate to the fire. In an aspect of certain embodiments, the signal is sufficient to disperse at least a portion of the plasma. In other embodiments, transmitting a signal proximate to the fire might comprise generating a set of one or more compression waves proximate to the fire. The one or more compression waves collectively may be sufficient to disperse at least a portion of the plasma.

### BRIEF DESCRIPTION OF THE DRAWINGS

A further understanding of the nature and advantages of particular embodiments may be realized by reference to the remaining portions of the specification and the drawings wherein like reference numerals are used throughout the several drawings to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a process flow diagram illustrating a method of suppressing a fire in accordance with various embodiments of the invention.

FIGS. 2A and 2B illustrates two waves having different wave shapes, in accordance with various embodiments.

FIG. 3 is a block diagram illustrating a system for suppressing a fire, in accordance with various embodiments.

FIG. 4 is a generalized schematic diagram illustrating a computer system, in accordance with various embodiments of the invention.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. In the following description, for the purposes of explanation, numerous specific details are set forth in order to provide a thorough understanding of the described embodiments. It will be apparent, however, to one skilled in the art that other embodiments of the present invention may be practiced without some of these specific details. In other instances, well-known structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Various embodiments provide tools and techniques for suppressing fires. These embodiments are based, in many cases, on the recognition that fire is a cold plasma consisting primarily of light, fast moving, negatively-charged electrons and slower, heavier, positively-charged ionic nuclei. Without a stable plasma, a typical fire cannot continue to exist. Hence, certain embodiments employ the principles of plasma physics to the art of fire suppression. The Incorporated Applications describe many of the principles that underlie the embodiments described herein.

Certain embodiments, for example, transmit a signal that generates one or more waves (which might be mechanical waves, electromagnetic waves, and/or the like) that are sufficient to disrupt the relationship between the electrons in a fire and the ionized nuclei to which those electrons are attracted. In effect, this signal provides the appropriate amount of energy to match the ionization energy required to remove the electrons from their orbits within the plasma. Once the electrons are removed, the plasma consists predominately of positive ions. The resulting repulsion between these positive ions in the plasma of the fire can serve to destabilize and/or disperse the plasma, thereby suppressing the fire.

In some cases, certain embodiments generate a signal that produces compression waves. In many cases, slow compression may act merely to add energy to a fire, while intermediate compression might have no visible effect on a fire; in contrast, however, fast compression can remove energy in the fire, assisting in suppressing the fire. Hence, in one aspect, the compression waves generated by certain embodiments may produce a fast compression effect over an area (or volume) of the fire, resulting in the removal of the electrons from their orbits and the corresponding destabilization/dispersion of the plasma and suppression of the fire. Certain embodiments provide the ability to shape these waves to enhance this fast compression effect. Merely by way of example, as described in further detail below, certain embodiments employ a wave shaping technique to adjust the compression region of the longitudinal wave a sufficient distance to exert a fast compression effect over a substantial area (and/or volume) of the fire.

In accordance with other embodiments, the signal might be generated with a plasma dispersion frequency that is calculated (based for example, on measured characteristics of the fire) to resonate with the frequency of the plasma itself, allowing the signal to disrupt the bond between the electrons and the nuclei and, consequently, disperse the plasma of the fire. In an aspect, for example, the plasma dispersion frequency of the signal is relative to the plasma wave frequency (referred to herein as the “plasma frequency”) of the fire (which may be modified by compression waves, as described above).

A variety of different types of waves may be employed by various embodiments. Merely by way of example, some embodiments employ relatively low-frequency acoustic waves. A variety of different types of waves may be employed by other embodiments, including without limitation Langmuir waves, Upper Hybrid Oscillations, Ion Acoustic Waves, Electrostatic Ion Cyclotron Waves, Lower Hybrid Oscillations, Light Waves, O Waves, X Waves, R Waves, L Waves, Alfvén Waves, and/or Magnetosonic Waves.

Particular embodiments may employ various features to enhance this dispersive effect. Merely by way of example, in some embodiments, the electrons may be grounded out of the plasma once separated from the nuclei of the plasma, thereby aggravating the repulsive forces between the positively-charged nuclei and the repulsive forces between the negatively-charged electrons. An electron-grounding device, of which a Penning Trap is one of several examples, may be employed for this purpose.

Another enhancement that may be employed by various embodiments is the use of secondary compression. To name but one example, an airbag (similar, in some aspects, to the airbags used for passenger safety in vehicles) or other secondary compression device may be deployed near the fire. When rapidly expanded, the secondary compression device exerts additional compression on the fire, enhancing the dispersive effect of the transmitted signal.

Various embodiments can be employed on any scale. Merely by way of example, on a relatively small scale, a fire suppression system might be installed in the cabin of a aircraft or other vehicle, for suppressing cabin fires. On a larger scale, a signal generator might be installed on the exterior of such an aircraft or other vehicle, which can be flown proximate to a fire, such as a wildfire, to generate signals for suppressing the fire in accordance with various embodiments. In fact, the aircraft itself can act as a signal generator in some cases. Merely by way of example, the sonic boom generated by supersonic flight can produce a compression wave that will exert a fast compression effect on a fire, such as a wildfire, when the aircraft is flown proximate to the fire (e.g., directly over the fire, or directly across the path of the fire).

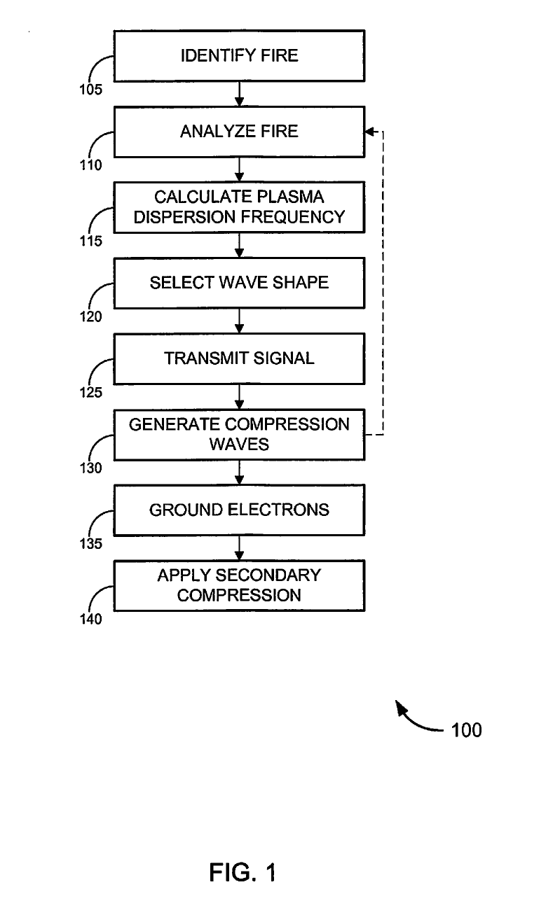

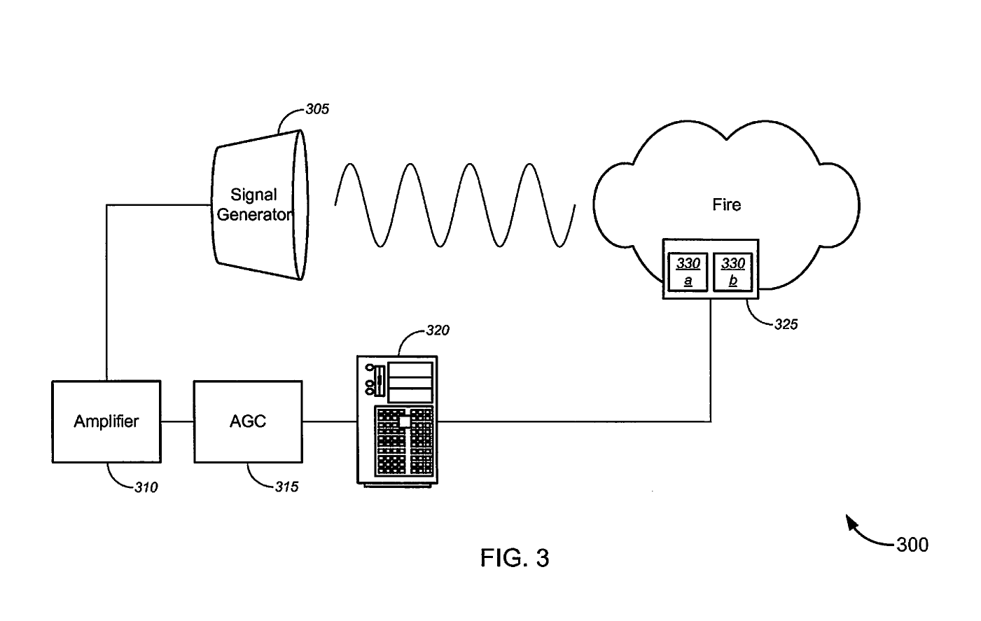

FIG. 1 illustrates a method 100 that can be used for fire suppression. While the method 100 is illustrated as a single method for ease of description, it should be appreciated that the various techniques and procedures described with respect to FIG. 1 can be combined in any suitable fashion, and various methods may omit, repeat and/or reorder the described operations (and/or include additional operations) within the scope of the several embodiments. Moreover, while the methods illustrated by FIG. 1 can be implemented by (and, in some cases, are described with respect to) the system 300 of FIG. 3 (or components thereof) described below, these methods can be implemented using any suitable hardware implementation. Similarly, while the system 100 of FIG. 3 (and/or components thereof) can operate according to the procedures illustrated by FIG. 1 (e.g., by executing instructions embodied on a computer readable medium), the system 100 can also operate according to other modes of operation and/or perform other suitable procedures.

The method 100 comprises identifying a fire (block 105). In accordance with various embodiments, identifying a fire might encompass a variety of procedures. For instance, in some cases, identifying a fire might simply comprise recognizing that a fire is occurring. This process might occur automatically and/or be facilitated through fire detection systems. Merely by way of example, in the case of a cabin fire in a vehicle, a heat sensor, smoke sensor, and/or the like might identify a fire automatically. In other cases, radar, photographic equipment, thermal imaging equipment, and/or other fire detection equipment may be used to identify a fire.

In other embodiments, identifying a fire might comprise additional procedures, including without limitation measuring a set of dimensions (in one, two, or three dimensions) of the fire, identifying a fuel source of the fire, measuring a temperature of the fire, measuring a plasma frequency of the fire, and/or the like. Hence, in some embodiments, the method 100 may include analyzing a fire and/or the plasma of which the fire is composed (block 110), to identify one or more characteristics of the fire and/or the plasma. Such characteristics can include one or more temperatures of the fire, one or more fuel sources of the fire, a plasma frequency of the fire and/or the like. (In an aspect of some embodiments, the procedures for analyzing a fire can be considered to be part of the identification of a fire.) The analysis of the fire and/or the plasma might include measuring one or more characteristics of the fire, for example with a probe. In some embodiments, a probe might include one or more sensors, as described below, which can measure the temperature of the fire, the plasma frequency of the plasma in the fire, and/or the like. Identifying and/or analyzing a fuel source of the fire might comprise analyzing a chemical composition of the fire itself, visually observing the fire to identify a material that is burning, and/or observing the frequency spectrum of the fire to identify a material that is burning. For instance, only twenty-three elements in the periodic table typically are capable of reaching the super heated temperatures necessary to become a cold plasma of a fire. Of these twenty-three elements, six are inert gases. By measuring the frequency spectra of the fire (e.g., using a spectrum analyzer), one can ascertain the nature of the burning material.

As noted above, certain embodiments transmit a signal having a plasma dispersion frequency in order to suppress the fire. Accordingly, the method 100 may comprise calculating (e.g., with a computer system) a plasma dispersion frequency for the signal to be generated. A plasma dispersion frequency is the frequency at which a signal can have a dispersive effect on the plasma; in an aspect, a signal at the plasma dispersion frequency may have the same velocity and/or phase as the plasma frequency of the flame. (As used herein, the term “velocity,” as it applies to plasmas and waves, should be interpreted to mean angular velocity unless specified otherwise.) In other words, a signal at the plasma dispersion frequency may exert control over the plasma. Thus, in an aspect, the appropriate plasma dispersion frequency may depend on the frequency of the plasma itself, and/or the orientation of the magnetic field in the plasma relative to the orientation of the transmitted signal. In some cases, it may be necessary or desirable to apply two signals simultaneously: one signal with a plasma dispersion frequency to control the electron plasma wave and a second signal with a plasma dispersion frequency to control the ion plasma wave.

Tables 1 and 2, below, list several equations that express the relationship between the plasma frequency and the appropriate plasma dispersion frequency for the transmitted signal. Each table lists the dispersion relationship (that is, the relationship of the plasma dispersion frequency to the plasma frequency for both electrons and ions in the plasma, under conditions in which the transmitted signal (expressed as \vec{k}) is either parallel to the orientation of the magnetic field (expressed as \vec{B₀}) or perpendicular to the orientation of the magnetic field, in which there is no magnetic field (\vec{B₀}=0).

TABLE 1
Dispersion Relationships for Electrostatic Conditions

| Oscil- | | | |
|---|---|---|---|
| lating | | | |
| species | Conditions | Dispersion relation | Name |
| electrons | \vec{B}₀ = 0 or \vec{k}∥\vec{B}₀ | ω² = ωₚ² + (3/2)k²vₜₕ² | plasma |
| | | | oscillation |
| | | | (or |
| | | | Langmuir |
| | | | wave) |
| | \vec{k} ⊥ \vec{B}₀ | ω² = ωₚ² + ω_{c}² = ωₕ² | upper |
| | | | hybrid |
| | | | oscillation |
| ions | \vec{B}₀ = 0 or \vec{k}∥\vec{B}₀ | ${ω}^{2} = {k}^{2} {v}_{s}^{2} = {k}^{2} \frac{{γ}_{e} {KT}_{e} + {γ}_{i} {KT}_{i}}{M}$ | ion acoustic wave |
| | \vec{k} ⊥ \vec{B}₀ (nearly) | ω² = Ω_{c}² + k²vₛ² | electrostatic |
| | | | ion |
| | | | cyclotron |
| | | | wave |
| | \vec{k} ⊥ \vec{B}₀ (exactly) | ω² = ωᵢ² = Ω_{c}ω_{c} | lower |
| | | | hybrid |
| | | | oscillation |

TABLE 2
Dispersion Relationships for Electromagnetic Conditions

| Oscillating | | | |
|---|---|---|---|
| species | Conditions | Dispersion relation | Name |
| electrons | \vec{B}₀ = 0 | ω² = ωₚ² + k²c² | light wave |
| | \vec{k} ⊥ \vec{B}₀, \vec{E}₁∥\vec{B}₀ | $\frac{{c}^{2} {k}^{2}}{{ω}^{2}} = 1 - \frac{{ω}_{p}^{2}}{{ω}^{2}}$ | O wave |
| | \vec{k} ⊥ \vec{B}₀, \vec{E}₁ ⊥ \vec{B}₀ | $\frac{{c}^{2} {k}^{2}}{{ω}^{2}} = 1 - \frac{{ω}_{p}^{2}}{{ω}^{2}} \frac{{ω}^{2} - {ω}_{p}^{2}}{{ω}^{2} - {ω}_{h}^{2}}$ | X wave |
| | \vec{k}∥\vec{B}₀ (right circular polarization | $\frac{{c}^{2} {k}^{2}}{{ω}^{2}} = 1 - \frac{{ω}_{p}^{2} / {ω}^{2}}{1 - ( {ω}_{c} / ω )}$ | R wave (whistler mode) |
| | \vec{k}∥\vec{B}₀ (left circular polarization) | $\frac{{c}^{2} {k}^{2}}{{ω}^{2}} = 1 - \frac{{ω}_{p}^{2} / {ω}^{2}}{1 + ( {ω}_{c} / ω )}$ | L wave |
| Ions | \vec{B}₀ = 0 | | none |
| | \vec{k}∥\vec{B}₀ | ω² = k²v_{A}² | Alfvén wave |
| | \vec{k} ⊥ \vec{B}₀ | $\frac{{ω}^{2}}{{k}^{2}} = {c}^{2} \frac{{v}_{s}^{2} + {v}_{A}^{2}}{{c}^{2} + {v}_{A}^{2}}$ | magnetosonic wave |

Table 1 expresses dispersion relationships under electrostatic conditions (where there is no oscillating magnetic field and/or the waves are longitudinal in nature), while Table 2 expresses dispersion relationships under electromagnetic conditions (where there is an oscillating magnetic field and/or there is a transverse component to the waves). The dispersion relation, in the tables, can be written as an expression for the frequency (squared), ω², but it is also common to write it as an expression for the index of refraction (squared), c²k²/ω². In each table, the following expressions are used:
ω=angular velocity of the signal=wave frequency
k=wave number of the signal

$$( k = \frac{2 π}{λ} ,$$

where λ is the wavelength of the signal)
ωₚ=plasma frequency
νₜₕ=velocity of thermal expansion
ω_{c}=electron gyrofrequency

$$( {ω}_{c} = \frac{eB}{{m}_{e} {c}^{′}}$$

where e is the elementary charge, B is the magnetic field, mₑ is the mass of an electron, and c is the speed of light
ωₕ=hybrid frequency of long wavelength oscillations in the plasma and electron cyclotron frequencies (wₕ²=wₚ²+w_{c}²)
νₛ=ion (plasma) sound speed
γₑ is taken to be unity
γᵢ is taken to be 3
K=Boltzmann's constant
Tₑ=temperature of the electrons in the plasma
Tᵢ=temperature of the ions in the plasma
M=mass of the ion
Ω_{c}=proton gyrofrequency
ωᵢ=ion frequency
ν_{A}=Alfvén velocity of the plasma

$${v}_{A} = \frac{B}{{( 4 π {n}_{i} {m}_{i} )}^{1 / 2}} = 2.18 \times {10}^{11} {μ}^{- 12} {n}_{i}^{- 1 / 2} B cm \text{/} s ,$$

where nᵢ is the number of ions per mole, mᵢ is the ion mass, and μ is the magnetic moment.

Given the relationships in the table, together with the measured characteristics of the plasma (e.g., the plasma frequency and which species—ions or electrons—is oscillating), and the prevailing environmental conditions (e.g., magnetic field orientation relative to the transmitted signal), the appropriate plasma dispersion frequency can be calculated.

Alternatively and/or additionally to transmitting the signal at the plasma dispersion frequency, certain embodiments may transmit the signal in such a way as to produce a compression effect on the plasma in the fire. In particular, the signal may be designed in such a way as to produce one or more compression waves directed toward the fire. In a particular aspect, these compression waves may be longitudinal waves, which can be created by pulsing a signal source (e.g., an acoustic signal source, a Doppler or phased-array radar source, a laser, etc.); in such cases, the pulse duration may correspond to the compression portion of the longitudinal wave, and the pause between the pulses may correspond to the rarefaction portion of the longitudinal wave. Alternatively and/or additionally, a series of pulsing transverse waves may be used to create a similar effect, and/or or the wave may comprise high amplitude transverse waves with the clipping applied to the top and bottom of the wave (as with diode clamping) to keep the wave within a predetermined amplitude range.

In a particular aspect, it may be beneficial to ensure that the wave exerts a fast compression effect across a substantial portion (or all) of the area (or volume, from a three dimensional perspective) of the fire. This is because fast compression may have a more substantial effect (relative to slow compression or intermediate compression) in removing electrons in the plasma from their orbits. Accordingly, if the dimensions of the fire are known, an appropriate wave shape may be selected to ensure that a fast compression effect is exerted on a desired portion of the fire (block 120).

As used herein “fast compression,” “intermediate compression” and “slow compression” describe the three types of shocks in magnetohydrodynamics (MHD): slow-mode, intermediate and fast-mode shocks. Shocks are transition layers across which there is a transport of particles. Intermediate shocks are non-compressive (meaning that the plasma density does not change across the shock). They are also isentropic. They are sometimes referred to as rotational discontinuities. All thermodynamic quantities are continuous across the shock, but the tangential component of the magnetic field can “rotate.”

Slow-mode and fast mode shocks are compressive and are associated with an increase in entropy. Across slow mode shocks, the tangential component of the magnetic field decreases. Across fast-mode shocks it increases.

The type of shocks depends on the relative magnitude of the upstream velocity in the frame moving with the shock with respect to some characteristic speed. Those characteristic speeds, the slow and fast magnetosonic speeds, are related to the Alfvén speed, V_{A}, and the sonic speed, cₛ, as follows:

$${a}_{slow}^{2} = \frac{1}{2} ⌊ ( {c}_{s}^{2} + {V}_{A}^{2} ) - \sqrt{{( {c}_{s}^{2} + {V}_{A}^{2} )}^{2} - 4 {c}_{s}^{2} {V}_{A}^{2} {cos}^{2} {θ}_{Bn}} ⌋ , \\ {a}_{fast}^{2} = \frac{1}{2} ⌊ ( {c}_{s}^{2} + {V}_{A}^{2} ) - \sqrt{{( {c}_{s}^{2} + {V}_{A}^{2} )}^{2} - 4 {c}_{s}^{2} {V}_{A}^{2} {cos}^{2} {θ}_{Bn}} ⌋ ,$$

where V_{A} is the Alfvén speed and θ_{Bn} is the angle between the incoming magnetic field and the shock normal vector.

The normal component of the slow shock propagates with velocity a_{slow} in the frame moving with the upstream plasma, that of the intermediate shock with velocity V_{An} and that of the fast shock with velocity a_{fast}. The fast mode waves have higher phase velocities than the slow mode waves because the density and magnetic field are in phase, whereas the slow mode wave components are out of phase.

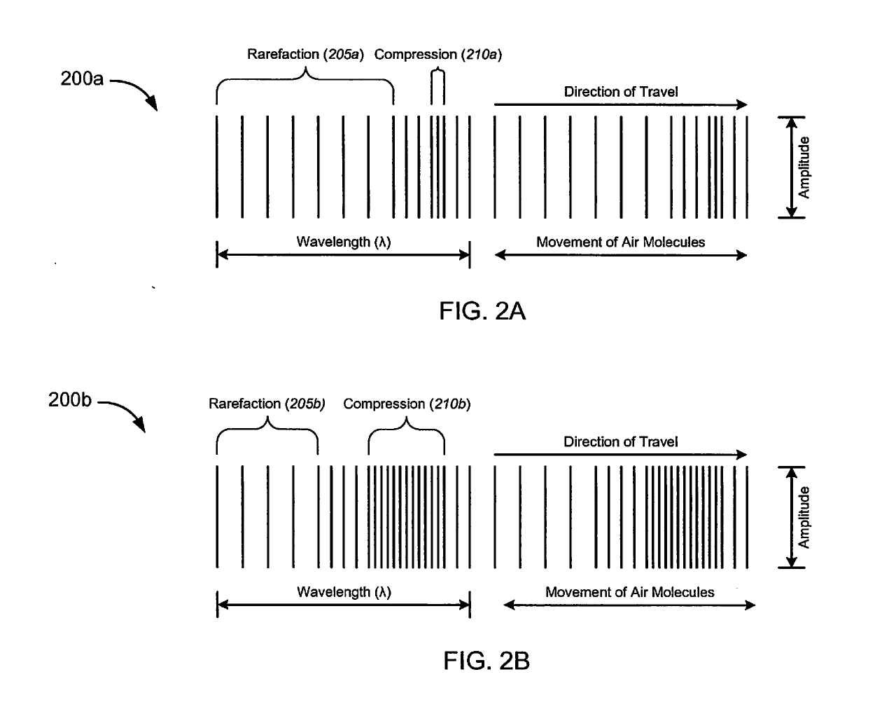

The term “wave shape” is used herein to describe the characteristics of a compression wave, and the term “wave shaping” is used herein to describe the process of developing and/or selecting a wave with a wave shape that exhibits a set of desired characteristics. These characteristics can include, but are not limited to, a frequency of the compression wave, the phase of the compression wave, the amplitude of the compression wave, and/or the regions of compression and rarefaction of the compression wave (relative to the wavelength), and any or all of these characteristics can define the wave shape of a wave. To illustrate the wave shaping technique employed by certain embodiments, FIGS. 2A and 2B illustrate two longitudinal waves 200a and 200b, respectively. Each of the waves 200 has a similar wavelength (λ), phase, and amplitude. However, the first wave 200a has a relatively larger region of rarefaction 205a (where the energy of the wave is expanded or relaxed), and a relatively smaller compression region 210a (where the energy of the wave is compressed) than that of the second wave 200b, which has a relative smaller rarefaction region 205b and a relatively larger compression region 210b. Wave shaping therefore is the crafting of a longitudinal wave in order to increase by a controlled amount the compression section of the wave. Waves transfer energy. By controlling the intensity and duration of the compression region of a longitudinal wave we can apply a specific amount of kinetic energy to a specific point in space over a specific amount of time. In this way, certain embodiments can optimize the effectiveness of the compression waves in dispersion the plasma in the fire (for example, by ensuring that a compression region of sufficient intensity exerts force on a desired portion of the plasma substantially simultaneously). Additionally, the other characteristics of the wave shape may be controlled as well.

In certain embodiments, the appropriate wave shape for the compression waves may be determined iteratively, as described below. In other cases, the initial wave shape may be selected based on properties of the plasma. Merely by way of example, if the fuel source of the fire is known, the ionization energy of the fuel source may be used as a target value to calculate the amount of energy required of the compression waves to remove the electrons from their shells. Many reference materials, including without limitation the Incorporated Applications, provide tables of ionization energies, with which a computer can be programmed in order to calculate the necessary energy to disperse the plasma. The wave shape (including the size and/or intensity of the compression region, the amplitude, the wavelength, the phase, etc.) can be selected to ensure that the generated compression wave(s) will have sufficient energy, over a sufficient portion of the fire, to disperse the plasma and suppress the fire.

The method 100 further comprises transmitting a signal with the appropriate characteristics proximate to the fire (block 125). As used herein, the term “proximate to the fire” means disposing the signal generator sufficiently close to the fire to ensure that the signal will have the intended effect on the fire. A variety of devices may be used, in accordance with various embodiments, to generate and/or transmit a signal. (In cases in which the transmission of the signal produces compression waves, the signal generator may be referred to as a “compression wave generator”). Merely by way of example, in some embodiments, the signal might comprise one or more acoustic waves, such that an acoustic speaker serves as the signal generator. In another embodiment, the signal might comprise radar waves (including without limitation pulsed radar waves), and a Doppler and/or phased array radar system might be used to generate a pulsed radar signal. Merely by way of example, a beamforming technique known in the art may be used to generate a composite signal from a plurality of signals generated by various radar sources in a phased array; this composite signal may be directed toward a fire and/or may be generated in such a way as to produce compression waves directed toward the fire. In other cases, a pulsed laser may be used generate compression waves.

In some cases, the signal will have the appropriate plasma dispersion frequency and/or will be designed to produce compression waves with the selected wave shape, as described above. In an aspect, the signal and/or the compression wave(s) will be sufficient to disperse the plasma, thereby suppressing the fire. The orientation of the transmitted signal relative to the orientation of the plasma's magnetic field may vary according to the embodiment (and in some cases cannot be controlled, if neither the location of the signal generator or the orientation of the magnetic field can be changed). Hence, the signal may be transmitted parallel to the magnetic field, perpendicular to the magnetic field, and/or the like. As noted above, the orientation of the signal relative to the magnetic field may influence the selection of the algorithm used to calculate the signal dispersion frequency of the signal.

In some cases, if applied quickly enough, the techniques provided by various embodiments can be used to mitigate the effects of an explosion. For example, the priority of reactions in a typical explosion is expressed by Table 3, below.

TABLE 3
Priority of Reactions in Explosions

| | | Products | |
|---|---|---|---|
| Priority | Composition of Explosive | of Decomposition | Phase |
| 1 | A metal and chlorine | Metallic Chloride | Solid |
| 2 | Hydrogen and chlorine | Hydrochloric acid | Gas |
| 3 | A metal and oxygen | Metallic oxide | Solid |
| 4 | Carbon and oxygen | Carbon monoxide | Gas |
| 5 | Hydrogen and oxygen | Water | Gas |
| 6 | Carbon Monoxide and oxygen | Carbon dioxide | Gas |
| 7 | Nitrogen | N₂ | Gas |
| 8 | Excess oxygen | O₂ | Gas |
| 9 | Excess Hydrogen | H₂ | Gas |
| 10 | Excess Carbon | Carbon | Solid |

During an explosion, the reactions will proceed according to the priority chain of Table 3; depending on the nature of the fuel source, some reactions may not occur, but the reactions that do occur generally will occur in the order listed. In some cases, the suppression techniques provided by various embodiments can be used to interrupt this priority chain, thereby preventing reactions later in the chain from occurring. For example, by applying a compression wave to suppress the metal-oxygen reaction, the carbon-oxygen reactions may be prevented and/or mitigated. It should be appreciated, of course, that the efficacy of this technique depends on the ability to apply an appropriate compression wave to the explosion quickly enough to interrupt one of the reactions in the priority chain.

In certain cases, the compression waves generated by various embodiments may be sufficient to offset or mitigate the shock wave created by an explosion. In a particular case, the compression wave may be sufficient to reduce the velocity of shrapnel produced by the explosion. Accordingly, various embodiments may be effective in protecting not only against a fire that results from an explosion, but also the concussive effects and/or the shrapnel produced by the explosion.

In other cases, various embodiments can be used to identify the composition of a fire, burning material, and/or explosive components/constituents using longitudinal waves. Typically, a traditional radar system can only identify objects if the radar waves travel through a relatively homogenous transmission medium (e.g., air) before reaching (and reflecting off of) the target to be sensed; if the transmission medium were a mix of different materials then the radar signal would not work correctly.

By using a longitudinal wave, however, one can use the echo reflections off of the different materials within a heterogeneous medium (such as a fire) to distinguish between different materials, and in some cases, to identify those materials. Sound travels at different speeds through each element in the periodic table. Hence, in some embodiments, it is possible to use the echoes from longitudinal waves to identify the material through which those waves travel, from a distance. The material may be the flame of a fire, the components of an explosive device, and/or the like. Thus, for example, longitudinal wave device (such as those disclosed herein) could be used to detect an improvised explosive device, among other things, as well as the elements which make up the device, from a distance.

As mentioned above, the process of analyzing a fire, calculating plasma dispersion frequency and/or selecting wave shape may be iterative (as indicated by the broken line between block 130 and 110 of FIG. 1). Hence, analyzing a fire might include (in addition or alternatively to the procedures described above), analyzing an amount of plasma dispersion caused by a first transmitted signal (and/or compression wave(s)). Merely by way of example, modern digital signal processing techniques provide a variety of methods by which the amount of plasma dispersion can be analyzed. Some of these techniques are discussed in detail in the Incorporated Applications. Examples of such techniques, which should be familiar to those skilled in the art, include double transform analyses, correlation-phase velocity analyses, fixed-probe correlation analyses, and local wavenumber-frequency spectra analyses.

In such cases, a feedback loop may be implemented in order to identify the optimal characteristics for a signal to suppress a particular fire. Merely by way of example, in an embodiment, a signal may be transmitted to generate a first set of one or more compression waves. The effect of the waves on the plasma (i.e., the amount of plasma dispersion caused by the waves) can be measured and analyzed, and this information can be used to select a second wave shape; a signal may then be transmitted to generate a second set of one or more waves having this same wave shape, and the process may be repeated iteratively until the appropriate wave shape is selected. Note that the second (or subsequent) wave shape may share some common characteristics with an earlier selected wave shape. For example, the second wave shape might have the same wavelength as the first wave shape, but a different compression region (or vice versa). Similarly, the second wave shape might have the same wavelength and compression region, but a different phase and/or amplitude than the first wave shape. Based on the disclosure herein, one skilled in the art will appreciate that a wide variation in wave characteristics may be used to create different wave shapes, for example, by using pulse-width modulation techniques.

In a set of embodiments, the method 100 further comprises grounding electrons from the plasma (block 135). As noted above, by removing electrons from their orbits, the plasma in the fire can be destabilized. This effect can be enhanced by grounding the free electrons; that is, removing them from the plasma entirely. A variety of grounding devices known in the art, including without limitation those described below, may be employed for this purpose.

In other embodiments, the method 100 comprises applying secondary compression to the fire (block 140). As used herein, the term “secondary compression” means any form of compression that may be applied to a plasma apart from compression waves generated by transmitting a signal proximate to the fire. This secondary compression can be used to augment the transmitted signal. Merely by way of example, if the signal is transmitted at a plasma dispersion frequency but does not generate compression waves, it may be sufficient remove electrons from their orbit, but compression can have a further destabilizing effect on the plasma. This compression may be generated by the signal itself, or, in other embodiments, may be supplied by a secondary compression device, such as an airbag or any other signal source capable of exerting relatively rapid compression on a given volume of space.

In some cases, precise calculations of wave shape and/or plasma dispersion frequency may be unnecessary and/or infeasible. For example, in the case of a wildfire, the size of the fire and/or the diversity of the fuel sources may make precise calculation of the appropriate signal difficult. In such cases, a signal that generates a relatively high-intensity compression wave over a wide area may be used. Merely by way of example, in some cases, a sonic boom can provide such a signal. Hence, in accordance with some embodiments, an aircraft (or other supersonic object) may be used as a signal generator to generate compressive waves directed toward a fire.

A sonic boom is created by an object (such as an aircraft) traveling a supersonic velocities. All objects moving through the air produce pressure waves as they compress the air in front of them. A sonic boom is created when an object, moving faster than the speed of sound, outpaces the pressure waves it creates; this produces shock waves that travel forward from a release point. As the object travels forward, it continually creates these shock waves, which in fact are fast compression waves. A similar effect can be obtained on the ground, for example, by pointing a jet engine at a fire and then powering the engine up to produce supersonic exhaust from the engine.

The shock wave created by a supersonic object in midair generally takes the form of a cone that radiates from the leading edge of the object. The portion of this cone that intersects the ground spreads broadly underneath the surface of the aircraft and is referred to as a “carpet boom.” As a general matter, the width of this carpet (i.e., the width of the compression waves at ground level) is about one mile for each 1000 feet of altitude at which the object is flying. The compression wave will always reach the ground forward of the point at which it was generated. The magnitude of the compression wave is affected by several factors, including the aircraft dimensions and mass, the aircraft's speed, altitude, and angle of attack, and any maneuvers performed by the aircraft.

For example, there are two types of compression waves generated by supersonic flight: N-waves and U-waves. Steady flight conditions typically generate an N-wave, which is shaped like the letter “N,” will have a frontal shock to a peak overpressure (compression), followed a linear decrease in the pressure (rarefaction) until the rear shock returns to ambient pressure. The U-wave is a more focused wave, which is generated by maneuvering (changes in direction), and is shaped like the letter “U.” U-waves produce positive shocks at the front and rear of the boom; in these shocks, the peak overpressures (compression) are greater (generally by two to five times) than those produced by an N-wave. However, the area of effect of a U-wave's peak overpressures (compression) is relatively small. Depending on the nature of the fire, either an N-wave or a U-wave may be appropriate in different circumstances. Moreover, parameters such as altitude, direction of travel (relative to a ground fire and/or to the prevailing wind), angle of attack, and aircraft dimensions can be selected or adjusted to produce an optimal boom shape for dispersing the plasma of a fire on the ground. For example, an aircraft in a dive will produce a more focused boom (greater magnitude over a smaller area), while a climbing aircraft will produce a more diffuse boom. Depending on the nature and dimensions of the fire, either a more focused boom or a more diffuse boom might be relatively more effective at diffusing the plasma of the fire.

Thus, a low altitude sonic boom creates a shock wave with a compression portion and a rarefaction portion During compression the electrons and ions are pushed apart. During rarefaction the electrons and ions are pulled back together. In an aspect, of some embodiments, the sonic boom can be immediately followed by the release of an endothermic substance, examples of which include, but are not limited to, Ammonium Nitrate and Barium Hydroxide, into the rarefaction portion of the shock wave; these agents can remove energy from the fire, so that the flames do not reform. Alternatively and/or additionally, a liquid mist such as water may be used for this purpose.

FIG. 3 illustrates a system 300 that can be used to suppress a fire. As noted above, the system 300 can implement various procedures in the method 100 but may also operate in any other appropriate fashion. The system 300 includes a signal generator 305, which is used to generate and/or transmit a signal (such as the signals described above) proximate to a fire. The signal generator 305 (as well as other components of the system 300) may be located in appropriate locations, which can depend on the sort of fire to be suppressed. Merely by way of example, the signal generator 305 might be mounted on the interior of a vehicle, such as a land vehicle, an aircraft, a watercraft, or a spacecraft, for suppressing fires inside such a vehicle. Alternatively, the signal generator 305 might be mounted on the exterior of such a vehicle, for suppressing fires in the open, such as wildfires. In other cases, the signal generator 305 might be mounted (or otherwise disposed) inside of a building, to suppress fires that occur inside the building.

In some cases is may be practical and/or desirable to use multiple signal generators. For example, multiple high frequency sources (signal generators) can be used in coordination to make one low frequency signal. In one aspect of certain embodiments, it may be desirable for the generated signal not disturb the people around it. This can be accomplished by adding multiple, high frequency ultrasonic signals together to make one lower frequency output signal. In an aspect, the generators may be arranged so that the output signal will only be heard at the destination (e.g., the location of the fire), where the multiple high frequency signals come together. In one embodiment, for example, several hundred (e.g., 443) input ultrasound signals can be added together to make one controlled low frequency output signal.

As noted above, a wide variety of signal generators may be used, and if the transmitted signal produces compression waves, the signal generator 305 may be considered to be a compression wave generator. Merely by way of example, and without limitation, the signal generator 305 might comprise one or more acoustic speakers, radar systems (e.g., Doppler radar systems, phased array radar systems, etc.), and/or any device that is capable of generating a signal sufficient to suppress a fire in accordance with various embodiments. In some cases, the signal generator 305 might comprise one or more laser systems. In certain embodiments, an infrared pulsed laser, a carbon dioxide laser, and/or a nitrogen laser may be employed. Merely by way of example, a carbon dioxide laser may be used as a carrier, and a pulsed nitrogen laser may be used to impart the signal on the carrier, thereby producing compression waves. In such embodiments, the carbon dioxide laser might be used to hold the fire at the plasma dispersion frequency, and/or the pulsed nitrogen laser might be used to knock the electrons out of their orbits by producing compression waves.

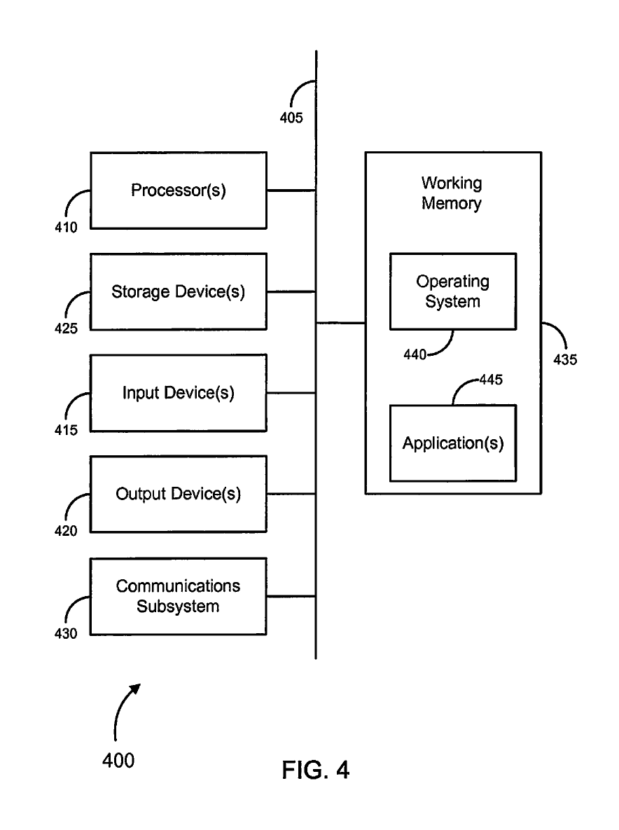

The system 300 may comprise an amplifier 310, which can be used to drive the signal generator 305, and/or an active gain control circuit (“AGC”) 315 in communication with the amplifier 310 and/or the signal generator 305. The AGC 315 can be used to define the characteristics of the signal and/or the compression waves produced by the signal (e.g., to generate compression waves with the desired wave shape), and/or to implement the feedback loop described above with respect to the method 100. In some cases, the AGC 315 may employ field-programmable gate arrays (“FPGA”) to allow circuits in the AGC 315 to be reconfigured to implement design changes without requiring production of new circuit boards. The AGC 315 may be in communication with (and/or incorporated within) a computer system 320. In some cases, the computer 320 comprise a special purpose computer such as a digital signal processor; in other cases, the computer system 320 may comprise a general purpose computer. In either case, the computer system 320 may be programmed with instructions for performing various procedures in accordance with the method 100 described above. The computer system might comprise one or more computers, each of which may be implemented by any appropriate architecture. Merely by way of example, FIG. 4, below, describes a computer that may be implemented within the computer system 320.

The computer 320, in some embodiments, receives input from a probe 325, which may contain one or more sensors 330 for measuring characteristics of the fire. Any of a variety of sensors 330 may be implemented. Merely by way of example, a sensor 330a, such as a thermocouple, may be used to measure a temperature of the fire and/or the plasma therein. As another example, a frequency sensor 330b may be used to measure a plasma frequency of the plasma.

Based on this input from the probe 325 (along with any other appropriate data, such as ionization energies, dispersion relationships, and/or the like), the computer system 320 can perform the functions of calculating plasma dispersion frequencies, identifying and/or analyzing a fire (including without limitation analyzing an amount of plasma dispersion, etc.), selecting wave shapes, and/or the like.

FIG. 4 provides a schematic illustration of one embodiment of a computer system 400 that can perform the methods provided by various other embodiments, as described herein, and/or can function as a computer system, as described above. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405 (or may otherwise be in communication, as appropriate). The hardware elements may include one or more processors 410, including without limitation one or more general-purpose processors and/or one or more special-purpose processors (such as digital signal processing chips, FPGAs, graphics acceleration processors, and/or the like); one or more input devices 415, which can include without limitation a mouse, a keyboard and/or the like; and one or more output devices 420, which can include without limitation a display device, a printer and/or the like.

The computer system 400 may further include (and/or be in communication with) one or more storage devices 425, which can comprise, without limitation, local and/or network accessible storage, and/or can include, without limitation, a disk drive, a drive array, an optical storage device, solid-state storage device such as an FPGA, a random access memory (“RAM”) and/or a read-only memory (“ROM”), which can be programmable, flash-updateable and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infra-red communication device, a wireless communication device and/or chipset (such as a Bluetooth™ device, an 802.11 device, a WiFi device, a WiMax device, cellular communication facilities, etc.), and/or the like. The communications subsystem 430 may permit data to be exchanged with a network (such as the network described below, to name one example), other computer systems, and/or any other devices described herein. In many embodiments, the computer system 400 will further comprise a working memory 435, which can include a RAM or ROM device, as described above.

The computer system 400 also can comprise software elements, shown as being currently located within the working memory 435, including an operating system 440, device drivers, executable libraries, and/or other code, such as one or more application programs 445, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be stored on a computer readable storage medium, such as the storage device(s) 425 described above. In some cases, the storage medium might be incorporated within a computer system, such as the system 400. In other embodiments, the storage medium might be separate from a computer system (i.e., a removable medium, such as a compact disc, etc.), and or provided in an installation package, such that the storage medium can be used to program, configure and/or adapt a general purpose computer with the instructions/code stored thereon. These instructions might take the form of executable code, which is executable by the computer system 400 and/or might take the form of source and/or installable code, which, upon compilation and/or installation on the computer system 400 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 400) to perform methods in accordance with various embodiments of the invention. According to a set of embodiments, some or all of the procedures of such methods are performed by the computer system 400 in response to processor 410 executing one or more sequences of one or more instructions (which might be incorporated into the operating system 440 and/or other code, such as an application program 445) contained in the working memory 435. Such instructions may be read into the working memory 435 from another computer readable medium, such as one or more of the storage device(s) 425. Merely by way of example, execution of the sequences of instructions contained in the working memory 435 might cause the processor(s) 410 to perform one or more procedures of the methods described herein.

The terms “machine readable medium” and “computer readable medium,” as used herein, refer to any medium that participates in providing data that causes a machine to operation in a specific fashion. In an embodiment implemented using the computer system 400, various computer readable media might be involved in providing instructions/code to processor(s) 410 for execution and/or might be used to store and/or carry such instructions/code (e.g., as signals). In many implementations, a computer readable medium is a physical and/or tangible storage medium. Such a medium may take many forms, including but not limited to, non-volatile media, volatile media, and transmission media. Non-volatile media includes, for example, optical and/or magnetic disks, such as the storage device(s) 425. Volatile media includes, without limitation, dynamic memory, such as the working memory 435. Transmission media includes, without limitation, coaxial cables, copper wire and fiber optics, including the wires that comprise the bus 405, as well as the various components of the communication subsystem 430 (and/or the media by which the communications subsystem 430 provides communication with other devices). Hence, transmission media can also take the form of waves (including without limitation radio, acoustic and/or light waves, such as those generated during radio-wave and infra-red data communications).

Common forms of physical and/or tangible computer readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400. These signals, which might be in the form of electromagnetic signals, acoustic signals, optical signals and/or the like, are all examples of carrier waves on which instructions can be encoded, in accordance with various embodiments of the invention.

The communications subsystem 430 (and/or components thereof) generally will receive the signals, and the bus 405 then might carry the signals (and/or the data, instructions, etc. carried by the signals) to the working memory 435, from which the processor(s) 405 retrieves and executes the instructions. The instructions received by the working memory 435 may optionally be stored on a storage device 425 either before or after execution by the processor(s) 410.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware and/or software configuration. Similarly, while various functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method of suppressing fires, the method comprising:
identifying a fire comprising plasma;
transmitting a pulsed electromagnetic signal proximate to the fire to produce a series of compression waves having a fast-mode shock effect within the plasma;
monitoring at least one characteristic of the fire in response to the pulsed electromagnetic signal; and
varying at least one parameter of the pulsed electromagnetic signal transmitted proximate to the fire in response to the monitoring.

2. The method of claim 1, wherein the compression waves produce an increase in a tangential component of a magnetic field within the plasma.

3. The method of claim 1, wherein the compression waves provide sufficient kinetic energy to match an ionization energy of electrons within the plasma and remove at least a portion of the electrons from their orbits.

4. The method of claim 1, wherein the at least one parameter of the pulsed electromagnetic signal is selected such that the compression waves resonate with a frequency of the plasma.

5. The method of claim 1, wherein the electromagnetic signal is configured to have at least one of a same velocity and a same phase as the plasma.

6. The method of claim 1, wherein identifying the flame comprises analyzing the plasma of the flame to identify a plasma frequency of the plasma; and
calculating a plasma dispersion frequency for the electromagnetic signal, based at least in part on the identified plasma frequency.

7. The method of claim 6, wherein calculating the plasma dispersion frequency for the signal comprises calculating the plasma dispersion frequency for the signal based at least in part on the identified plasma frequency and an orientation of a magnetic field of the plasma relative to the signal.

8. The method of claim 1, wherein generating one or more compression waves comprises:
generating a first series of electromagnetic pulses to produce a first set of one or more compression waves, and thereby provide kinetic energy within each electron orbit of the plasma, each having a first wave shape;
analyzing the amount of plasma dispersion caused by the first set of one or more compression waves;
selecting a second wave shape, based at least in part on an analysis of the amount of plasma dispersion caused by the first set of one or more compression waves; and
generating a second series of electromagnetic pulses to produce second set of one or more compression waves having the second wave shape.

9. The method of claim 8, wherein the first wave shape is defined by a first frequency and a first compression region, and wherein the second wave shape is defined by a second frequency and a second compression region.

10. The method of claim 8, wherein analyzing an amount of plasma dispersion comprises analyzing the amount of plasma dispersion using a digital signal processing technique selected from the group consisting of a double transform analysis, a correlation-phase velocity analysis, a fixed-probe correlation analysis, and a local wavenumber-frequency spectra analysis.

11. The method of claim 8, wherein generating a set of one or more waves comprises generating a set of one or more pulsed transverse waves.

12. The method of claim 8, wherein generating a set of one or more compression waves comprises generating a set of one or more compression waves with at least one of a Doppler radar system and a phased array radar system.

13. The method of claim 1, wherein transmitting a signal comprises transmitting a plurality of signals, and wherein generating a series of compression waves comprises beamforming a composite signal from the plurality of signals.

14. The method of claim 1, wherein transmitting a pulsed electromagnetic signal comprises transmitting the pulsed electromagnetic signal from a laser.

15. The method of claim 14, wherein the laser comprises a carbon dioxide laser.

16. The method of claim 14, wherein the laser comprises a nitrogen laser.

17. The method of claim 8, further comprising:
selecting a wave shape for the one or more compression waves, based at least in part on an ionization energy of the fuel source of the fire, wherein the selected wave shape produces a compression effect on the electron orbits of the flame plasma; and
wherein generating a set of one or more energy waves comprises wave shaping the set of one or more compression waves to have the selected wave shape.

18. The method of claim 1, wherein at least one of:
the fire is a wildland fire;
the fire is inside one or more of a building, a vehicle, an aircraft, a watercraft, and a spacecraft; and
the fire is generated by an explosion.

19. A system for suppressing a fire comprising plasma, the system comprising:
a signal generator for transmitting a signal proximate to the fire, wherein the signal is configured to produce a series of compression waves having a fast-mode shock effect on the plasma sufficient to disperse at least a portion of the plasma;
an active gain control circuit, in communication with the signal generator, for adjusting one or more characteristics of the signal; and
a computer system in communication with the active gain control circuit, the computer system comprising a processor and a set of instructions executable by the processor to control one or more characteristics of the signal.

20. The system of claim 19, wherein the processor comprises a digital signal processor, the system further comprises a probe for measuring one or more characteristics of the plasma, and wherein the set of instructions comprises:
instructions for calculating a plasma dispersion frequency for the fire, based at least in part on the one or more measured characteristics of the plasma; and
instructions to cause the active gain control circuit to adjust the frequency of the signal to the calculated plasma dispersion frequency.
